(19) United States
(12) Patent Application Publication
(10) Pub. No.: US 2016/0205910 A1
(43) Pub. Date: Jul. 21, 2016

(54) Fish Lure Device

(71) Applicant: David Eugene Nelson, Litchfield, MN (US)

(72) Inventor: David Eugene Nelson, Litchfield, MN (US)

(21) Appl. No.: 14/599,531

(22) Filed: Jan. 18, 2015

(51) Int. Cl. A01K 85/16; A01K 85/02; A01K 85/00

(52) U.S. Cl. CPC A01K 85/16; A01K 85/00; A01K 85/02

(57) ABSTRACT

A fish lure device having a main body (1), a plurality of wings (2), a plurality of attachment mechanisms (3), and one or more hook mechanisms (4). Additionally said fish lure device could include a skirt (5), one or more spiraled grooves (6), and a swivel device (7).

### FEDERALLY SPONSORED RESEARCH

Not Applicable

### SEQUENCE LISTING OR PROGRAM

Not Applicable

### BACKGROUND

1. Field of Invention

This invention relates to devices used for catching fish, specifically those devices collectively referred to as fishing lures.

2. Description of Prior Art

For years inventors have been developing various types of devices to attract and catch fish. Some of these devices are devices developed to catch many fish at once while others are singular devices tied to the end of a line and designed to catch just one fish at a time. Of the singular device type a variety of these devices are designed to dive deep in the water while others have characteristics that allow them to stay on the surface of the water and still others work in between these ranges. They can exhibit a plethora of noises, actions, and visual appearances and are made from a wide array of materials all with the designed purpose of attracting and catching a multitude of different sizes and types of fish. Although many types and designs have been developed fisherpersons are always looking for that next unique lure that will improve their chances of success.

Fishing lures have been described in the prior art, however, none of the prior art devices disclose the unique features of the present invention.

Many fishing lures such as U.S. Pat. Nos. 4,450,644, 4,510,710, 4,959,920, 5,144,765, 6,508,029, and 6,640,485 have a portion of the lure that is shaped in such a way as to allow that portion of the lure to spin around the longitudinal axis, or body, of the lure while the remainder of the lure does not rotate. This allows for disturbance of the water causing noise and vibration and also some reflection of light but since only a part of the lure is rotating the effect is not as substantial as if the entire lure were rotating around this axis.

Other lures such as U.S. Pat. Nos. 4,142,318, 4,174,584, 4,891,901, 5,367,816, 5,428,917, 6,108,961, 6,161,325, 4,416,080, and 6,176,035 are designed in such a way that they are bent or molded to create a spiral, corkscrew type of shape to the body of the lure to attempt to give the entire lure a rotating action as it is retrieved through the water. These lures have a spiral, corkscrew type of shape just to the singular, main body portion of the lure which lends itself to an unstable, unnatural, wobbling motion of the lure and also only allows for a minimal rotating motion to the lure. They lack components that would give them greater stability and greater rotation when retrieved through the water.

There are also lures developed such as U.S. Pat. Nos. 6,637,147, D466,180, 6,108,964, 6,044,583, 5,497,581, 5,353,540, 5,303,497, 5,016,387, and 4,819,362 that are bent or molded in such a way as to create winged like members that extend out from the many body of the lure and are positioned at an angulation that would attempt to create a rotation of the lure as it is retrieved through the water. These lures lack the additional component of spiral grooves in the main body of the lure which would give the lure additional rotation, provide additional stability to the lure as it is rotating through the water, and give the lure an enhanced appearance to add to the fish attraction characteristics of the lure. U.S. Pat. No. 5,016,387 also lacks a hook mechanism as part of its claims.

U.S. Pat. No. 5,003,723 has wings that move but, again, the lure is not designed to have a rotatory motion when retrieved through the water. U.S. Pat. No. 3,981,096 can have some random motions as it is retrieved through the water but, again, does not have a specific rotation component o the design. U.S. Pat. No. 4,869,012 has a fin or wing type design with these fins designed to cover up the hooks of a treble hook but the lure is not designed with any type of rotational component when retrieved through the water,

U.S. Pat. No. 7,874,094 and 4,637,158 have a design in which a portion of the lure is designed to rotate about the longitudinal axis, or body, of the lure but the remainder of the lure doesn't not create any significant type of rotatory effect.

U.S. Pat. No. 4,499,682 is designed to have a rotation component as it freefalls in decent but is not designed to specifically have a rotational component as it is retrieved through the water,

U.S. Pat. No. 7,644,533 is designed to have components of the lure that rotate in opposing directions to cause some “vibration” of the lure when retrieved through the water. U.S. Pat. No. 6,820,365 is also designed to have components of the lure that rotate in opposing direction to help attract fish and to help keep the lure upright during retrieval through the water. Neither of these lures have the same design or function as the lure of present invention.

### Objects and Advantages

Several objects and advantages of the present invention are:
a) To provide a fish lure in which the entire lure is designed to rotate along the longitudinal axis of the lure when retrieved at or near the surface of the water.
b) To provide a fish lure that is designed in such a manner that when it is rotating along its longitudinal axis it rotates symmetrically with a minimal amount of secondary, ancillary motions to the lure during retrieval.
c) To provide a fish lure that displays its designed movement characteristics with a simple retrieval of the lure through the water without the need for various motions and movements of the retrieval mechanism to allow the lure to move in the designed manner, allowing it to be retrieved effectively by even the novice fisherperson.
d) To provide a fish lure that displays a unique design and movement characteristics compared to any other fishing lure design to improve effectiveness and ease of use.
   Still further objects and advantages will become apparent from a consideration of the ensuing description and drawings.

### SUMMARY

In accordance with the present invention, a fish lure device comprises a main body, a plurality of wings, a plurality of attachment mechanisms, and one or more hook mechanisms. Additionally the fish lure device of present invention could include one or more one spiraled grooves in the main body, a skirt, and a swivel device.

### DRAWINGS

Drawing Figures

FIG. 1 illustrates what could be a top or bottom view of the preferred embodiment of the present invention.

FIG. 2 illustrates a side view of the preferred embodiment of the present invention.

FIG. 3 illustrates a front view of the preferred embodiment of the present invention,

FIG. 4 illustrates what could be a top or bottom view of an alternative embodiment of the present invention.

FIG. 5 illustrates what could be a top or bottom view of an alternative embodiment of the present invention.

### REFERENCE NUMERALS IN DRAWINGS

1 Main Body

2 Wing

3 Attachment Mechanism

4 Hook Mechanism

5 Skirt

6 Spiral Grooves

7 Swivel Device

### DETAILED DESCRIPTION

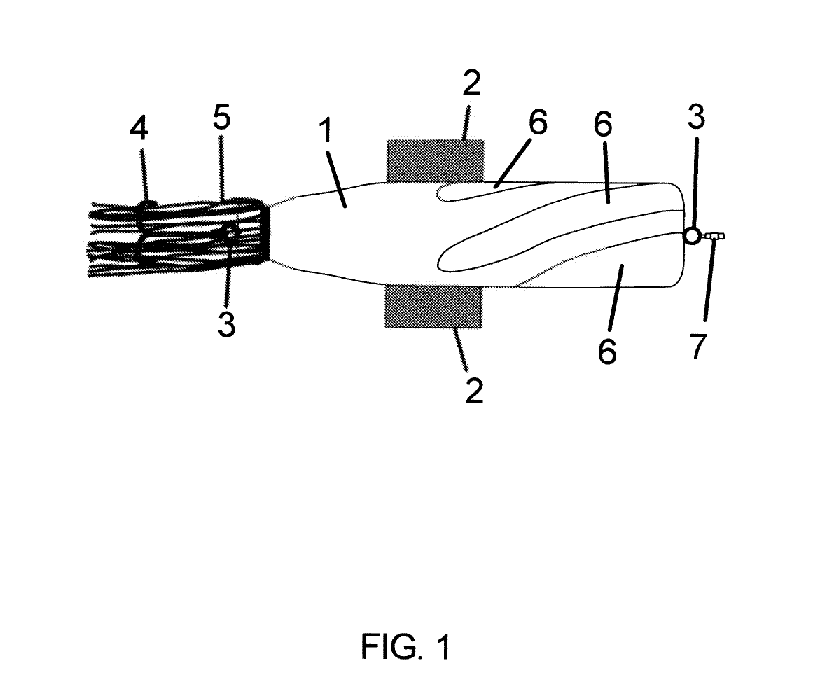

### Description—FIGS. 1-3—Preferred Embodiment

A preferred embodiment of the fish lure device is illustrated in FIG. 1-3. FIG. 1 illustrates what could be either a top or bottom view of the preferred embodiment of the fish lure device. The fish lure device includes a main body 1, a plurality of wings 2, a plurality of attachment mechanisms 3, one or more hook mechanisms 4, a skirt 5, one or more spiral grooves 6, and a swivel device 7, Said main body 1 would have at least one but could be a plurality of said spiral grooves 6 that would be present at the front end of the lure and could extend towards the back of the lure to whatever extent was desired. Said wings 2 would be positioned and orientated in such a way as to cause a rotation of said fish lure device when pulled through the water. The orientation of said wings would be in concert with said spiral grooves 6 such that they would be effecting a rotation of said fish lure device that was the same direction of rotation. Said attachment mechanism 3 could simply be an opening or hole in or about said fish lure device that allows it to be attached to other objects through various means such as hooks, clasps, string, fishing line, etc. Said hook mechanisms 4 could be a multitude of shapes or configurations including, but not limited to a single hook, treble hook, barbed hook, or barbless hook which is attached to said main body 1 via said attachment mechanism 3. Said skirt 5 would be positioned toward the back part of the lure. Said swivel device 7 would be connected to said attachment mechanism 3 at the front end of the fish lure device.

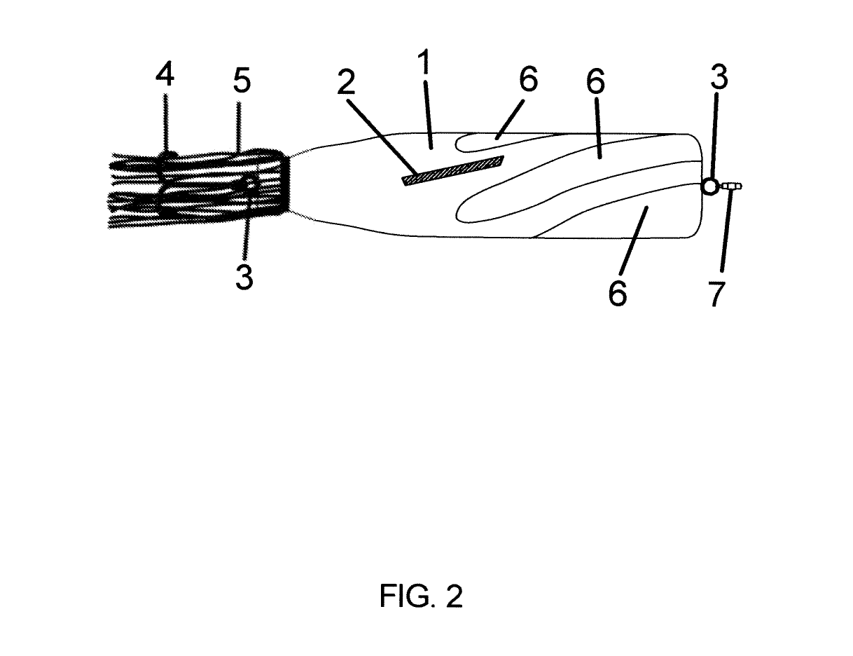

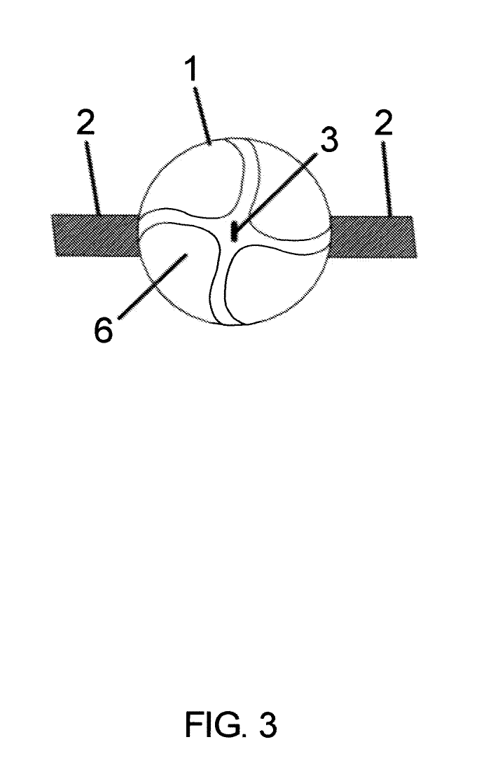

FIG. 2 illustrates a side view and FIG. 3 a front view of the preferred embodiment of said fish lure device displaying these same components and characteristics.

### Operation—FIGS. 1-3—Preferred Embodiment

In the preferred embodiment of present invention, said main body 1 would be attached to said swivel device 7, which is commonly used in fishing, via said attachment mechanism 3. Said swivel device 7 would then be attached to a fishing line. Said fish lure device would rotate about its longitudinal axis as it is pulled through the water. Said fish lure device could be attached directly to a fish line, or other device, via said attachment mechanism 3 and function similarly but said swivel device 7 would allow said fish lure device to spin more freely. Said wings 2 and said spiral grooves 6 would cause a rotational motion of said fish lure device about its longitudinal axis and this rotational motion, in combination with being pulled through the water, would cause a disturbance in the water that would attract predator fish. In addition, this rotational motion would cause a flashing of color and reflection of light from the surface of said fish lure device and cause movement of said skirt 5 which would make it appear to be a bait fish moving through the water and would, therefore, attract predator fish. When the predator fish would strike said fish lure device the predator fish would be caught by said hook mechanism 4. Additionally the present invention allows the fisherperson to achieve the desired action of the fish lure device with a simple retrieval of the lure through the water without the need for various motions and movements of the retrieval mechanism to allow the lure to move in the designed manner.

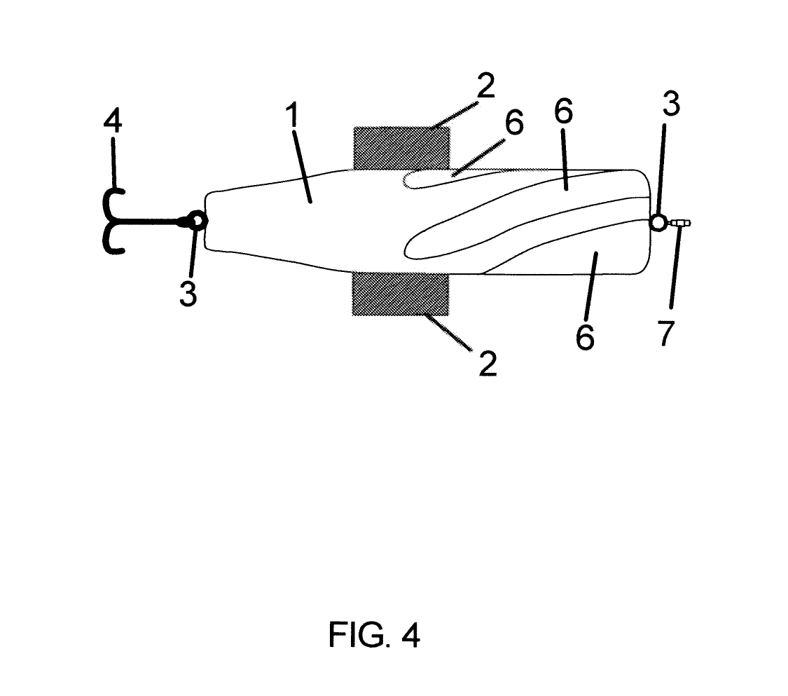

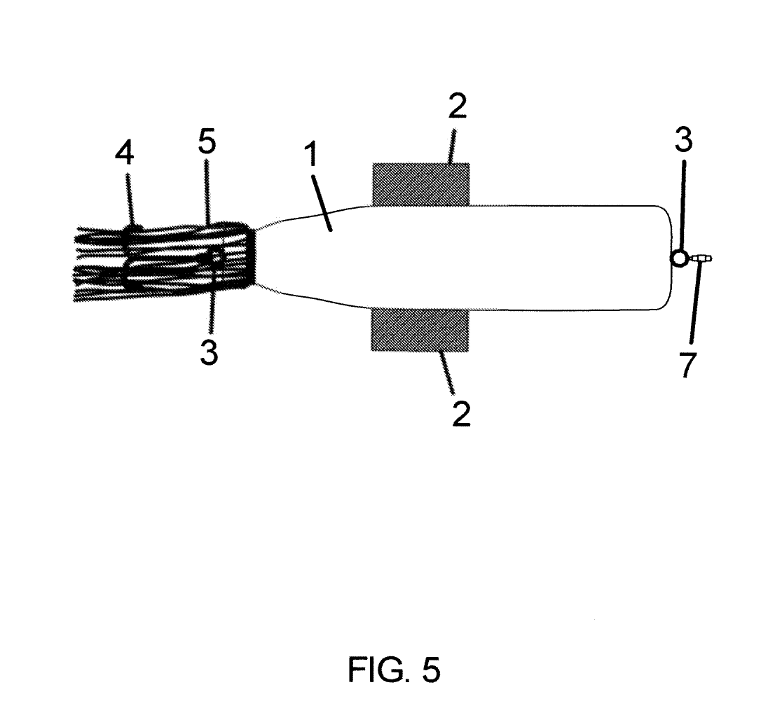

### Description & Operation—FIG. 4-5—Alternate Embodiment

Additional alternate embodiments of said fish lure device could include all of the components and characteristics as described above with the exclusion of said skirt 5, as depicted in FIG. 4, and/or the exclusion of said spiral grooves 6, as depicted in FIG. 5. The exclusion of said skirt 5 would decrease the predator fish attraction characteristics but overall would not change the function of said fish lure device. The exclusion of said grooves 6 could decrease the rotational capabilities and the predator fish attraction characteristics but overall said fish lure device would still function in an acceptable manner

### CONCLUSIONS, RAMIFICATIONS, AND SCOPE OF INVENTION

Thus the reader will see that the fish lure device of present invention provides a unique and innovative approach to attracting and catching fish. The device provides a fish lure in which the entire lure is designed to rotate along the longitudinal axis of the lure at or near the surface of the water when retrieved through the water and is able to do this in such a manner that when it is rotating along its longitudinal axis it rotates symmetrically with a minimal amount of secondary, ancillary motions to the lure during retrieval. The device also provides a fish lure that displays its designed movement characteristics with a simple retrieval of the lure through the water without the need for various motions and movements of the retrieval mechanism to allow the lure to move in the designed manner, allowing it to be retrieved effectively by even the novice fisherperson. The fish lure of present invention displays a unique design and movement characteristics compared to any other fish lure design to improve effectiveness and ease of use.

While my above options contain many specificities, these should not be construed as limitations on the scope of the invention, but rather as an exemplification of one preferred embodiment and a few alternative embodiments there of. Many other variations are possible. For example, the fish lure device could be made out of a variety of materials including, but not limited to, various metals, woods, or plastics. The attachment mechanism could have a variety of shapes and configurations but would all have the same function of allowing the fish lure device to be attached to another object(s). The hook mechanism could have a variety of shapes, be made out of a variety of materials, and have a multitude of configurations all of which would not have a significant effect on the overall function and design of the fish lure device of present invention. The wings could have variations in placement, orientation, and size. The spiral grooves could have a variety of widths, depths, and orientations. The device could also have some variations in thickness, depth, width, and length that could change the appearance of the lure to some degree but the overall function and action of the lure would remain the same.

Thus the scope of the invention should be determined by the appended claims and their legal equivalents, rather than by the examples given.

I claim:

1. A fish lure device including: (a) a main body (b) a plurality of wings (c) a plurality of attachment mechanisms (d) one or more hook mechanisms.

2. The fish lure device of claim 1, further including: (a) a swivel device.

3. The fish lure device of claim 1, further including: (a) skirt.

4. The fish lure device of claim 1, further including: (a) one or more spiraled grooves.

5. The fish lure device of claim 1, further including: (a) a swivel device (b) skirt.

6. The fish lure device of claim 1, further including: (a) a swivel device (b) one or more spiraled grooves.

7. The fish lure device of claim 1, further including: (a) a swivel device (b) skirt (c) one or more spiraled grooves.

8. The fish lure device of claim 1, further including: (a) skirt (b) one or more spiraled grooves.
